(19) United States
(12) Patent Application Publication
(10) Pub. No.: US 2020/0120982 A1
(43) Pub. Date: Apr. 23, 2020

(54) ELECTRONIC CIGARETTE DEVICE AND CIGARETTE CARTRIDGE USED THEREFOR

(71) Applicant: TDK Corporation, Tokyo (JP)

(72) Inventor: Kei TANABE, Tokyo (JP)

(21) Appl. No.: 16/626,775

(22) PCT Filed: Jun. 27, 2018
(86) PCT No.: PCT/JP2018/024274

§ 371 Date: Dec. 26, 2019

(30) Foreign Application Priority Data
Jun. 30, 2017 (JP) 2017-128177

(51) Int. Cl. A24F 40/42; A24F 40/51; G06K 7/08

(52) U.S. Cl. CPC A24F 40/42; G06K 7/087; A24F 40/51

(57) ABSTRACT

An object is to provide an electronic cigarette device capable of reliably acquiring more information concerning a cigarette cartridge. An electronic cigarette device includes an electronic cigarette device body and a cigarette cartridge allowing a user to smoke when being attached to the electronic cigarette device body. The electronic cigarette device body has a magnetic sensor and a control circuit for analyzing an output signal from the magnetic sensor. The cigarette cartridge has magnetic patterns. When the cigarette cartridge is attached to the electronic cigarette device body, a magnetic field generated from the magnetic patterns is detected by the magnetic sensor. Thus, as compared to the case where a change in electrostatic capacity is utilized, more information concerning the cigarette cartridge can be reliably acquired.

### TECHNICAL FIELD

The present invention relates to an electronic cigarette device and, more particularly, to an electronic cigarette device capable of identifying a cigarette cartridge. The present invention relates also to a cigarette cartridge used for such an electronic cigarette device.

### BACKGROUND ART

Recently, in place of a conventional cigarette involving burning of dried tobacco leaves, there is developed an electronic cigarette device of a type in which tobacco leaves are not burnt but merely heated to generate vapor to be breathed (see Patent Documents 1 to 3). In particular, the electronic cigarette device described in Patent Document 3 is configured to identify a cigarette cartridge by detecting a change in electrostatic capacity generated when the cigarette cartridge is attached to the body thereof.

### CITATION LIST

[Patent Document]

[Patent Document 1] JP 2009-509521

[Patent Document 2] JP 2016-534730

[Patent Document 3] JP 2017-510270

### SUMMARY OF INVENTION

### Problem to be Solved by the Invention

However, the electronic cigarette device described in Patent Document 3 identifies a cigarette cartridge by utilizing a change in electrostatic capacity generated when the cigarette cartridge is attached to the body thereof, so that not only acquired information amount is small, but also identification reliability is low since the electrostatic capacity significantly changes depending on the positional relationship between the electronic cigarette body and cigarette cartridge.

It is therefore an object of the present invention to provide an electronic cigarette device capable of reliably acquiring more information concerning the cigarette cartridge and a cigarette cartridge used therefor.

### Means for Solving the Problem

A cigarette cartridge according to the present invention is a cigarette cartridge allowing a user to smoke when being attached to an electronic cigarette device body and includes at least one of a magnetism generation part that generates a magnetic field indicating predetermined information and a magnetic sensor that detects the magnetic field.

According to the present invention, information is acquired by a combination of the magnetism generation part and magnetic sensor, so that as compared to the case where a change in electrostatic capacity is utilized, more information concerning the cigarette cartridge can reliably be acquired.

The cigarette cartridge according to the present invention may include a magnetism generation part constituted by a plurality of magnetic patterns. With this configuration, much information can be embedded only by printing the magnetic patterns in the cigarette cartridge by using magnetic ink or the like, making it possible to suppress increase in manufacturing cost.

In the cigarette cartridge according to the present invention, when the attachment direction of the cigarette cartridge to the electronic cigarette device body is the axial direction, a plurality of axially extending magnetic patterns may be peripherally arranged. Alternatively, when the attachment direction of the cigarette cartridge to the electronic cigarette device body is the axial direction, a plurality of magnetic patterns extending in radial direction may be radially arranged. Thus, when the magnetic patterns and magnetic sensor are relatively rotated, information embedded in the cigarette cartridge can be scanned. Accordingly, when the cigarette cartridge can be threadably engaged to the electronic cigarette device body having the magnetic sensor by peripherally rotating the cigarette cartridge, information can be read in conjunction with the attachment operation.

In the cigarette cartridge according to the present invention, when the attachment direction of the cigarette cartridge to the electronic cigarette device body is the axial direction, a plurality of peripherally extending magnetic patterns may be axially arranged. With this configuration, it is possible to scan information embedded in the cigarette cartridge by relatively axially moving the magnetic patterns and magnetic sensor, regardless of the peripheral position of the magnetic sensor. Accordingly, when the cigarette cartridge can be attached to the electronic cigarette device body having the magnetic sensor by axially inserting the cigarette cartridge, information can be read in conjunction with the attachment operation.

In the cigarette cartridge according to the present invention, when the attachment direction of the cigarette cartridge to the electronic cigarette device body is the axial direction, a plurality of dot-like magnetic patterns may be peripherally and axially arranged. With this configuration, more information can be embedded in the cigarette cartridge.

The cigarette cartridge according to the present invention may have a magnetism generation part constituted by a coil. This allows generation of an arbitrary magnetic field according to a current pattern to be made to flow in the coil.

An electronic cigarette device according to the present invention includes an electronic cigarette device body and a cigarette cartridge allowing a user to smoke when being attached to the electronic cigarette device body. The electronic cigarette device has a magnetism generation part that generates a magnetic field indicating predetermined information, a magnetic sensor that detects the magnetic field, and a control circuit that analyzes an output signal from the magnetic sensor. The control circuit is provided in the electronic cigarette device body, and at least one of the magnetism generation part and magnetic sensor is provided in the cigarette cartridge. When the cigarette cartridge is attached to the electronic cigarette device body, the magnetic field generated by the magnetism generation part can be detected by the magnetic sensor.

According to the present invention, attachment of the cigarette cartridge to the electronic cigarette device body allows detection of the magnetic field, so that as compared to the case where a change in electrostatic capacity is utilized, more information concerning the cigarette cartridge can be reliably acquired.

In the present invention, the magnetism generation part may be constituted by a plurality of magnetic patterns formed in the cigarette cartridge, and the magnetic sensor may be provided in the electronic cigarette device body. With this configuration, information can be embedded only by printing the magnetic patterns in the cigarette cartridge by using magnetic ink or the like, thus making it possible to suppress increase in manufacturing cost.

In the present invention, when the attachment direction of the cigarette cartridge to the electronic cigarette device body is the axial direction, a plurality of axially extending magnetic patterns may be peripherally arranged in the cigarette cartridge. Alternatively, when the attachment direction of the cigarette cartridge to the electronic cigarette device body is the axial direction, a plurality of magnetic patterns extending in radial direction may be radially arranged in the cigarette cartridge. Thus, when the electronic cigarette device body and cigarette cartridge are relatively rotated, information embedded in the cigarette cartridge can be scanned.

In the present invention, when the attachment direction of the cigarette cartridge to the electronic cigarette device body is the axial direction, a plurality of peripherally extending magnetic patterns may be axially arranged in the cigarette cartridge. With this configuration, it is possible to scan information embedded in the cigarette cartridge by inserting the cigarette cartridge into the electronic cigarette device body, regardless of the peripheral position of the magnetic sensor.

In the present invention, when the attachment direction of the cigarette cartridge to the electronic cigarette device body is the axial direction, a plurality of dot-like magnetic patterns may be peripherally and axially arranged in the cigarette cartridge. With this configuration, more information can be embedded in the cigarette cartridge.

In the present invention, the magnetic sensor may detect the magnetic field in conjunction with an attachment operation of attaching the cigarette cartridge to the electronic cigarette device body. This allows information embedded in the cigarette cartridge to be read without an additional operation by a user. In this case, when the attachment direction of the cigarette cartridge to the electronic cigarette device body is the axial direction, the attachment operation may be a rotation operation with the axial direction set as the rotating axis or may be an axial insertion operation. The rotation operation is suitable when the cigarette cartridge is threadably engaged with the electronic cigarette device body, and the insertion operation is suitable when the cigarette cartridge is inserted into the electronic cigarette device body.

In the present invention, the magnetism generation part may be constituted by a coil, and the control circuit may make current flow in the coil in a state where the cigarette cartridge is attached to the electronic cigarette device body. This allows generation of an arbitrary magnetic field according to a current pattern to be made to flow in the coil.

### Advantageous Effects of the Invention

As described above, according to the present invention, there can be provided an electronic cigarette device capable of reliably acquiring more information concerning the cigarette cartridge and a cigarette cartridge used therefor.

### BRIEF DESCRIPTION OF DRAWINGS

FIG. 1 is a schematic perspective view illustrating the outer appearance of an electronic cigarette device 100 according to a first embodiment of the present invention.

FIG. 2 is a schematic view for explaining the configuration of the electronic cigarette device 100.

FIG. 3 is a view illustrating a state where the cigarette cartridge 120 is attached to the electronic cigarette device body 110.

FIG. 4 is a partially cut view of the cigarette cartridge 120.

FIG. 5 is a partially cut view of the cigarette cartridge 120 according to a first modification.

FIG. 6 is a partially cut view of the cigarette cartridge 120 according to a second modification.

FIG. 7 is a schematic view for explaining the configuration of an electronic cigarette device 200 according to a second embodiment.

FIG. 8 is a partially enlarged perspective view of the cigarette cartridge 220.

FIG. 9 is a schematic view for explaining the configuration of an electronic cigarette device 300 according to a third embodiment of the present invention.

FIG. 10 is a partially cut view of the cigarette cartridge 320.

FIG. 11 is a partially cut view of the cigarette cartridge 320 according to a first modification.

FIG. 12 is a partially cut view of the cigarette cartridge 320 according to a second modification.

FIG. 13 is a schematic view for explaining the configuration of an electronic cigarette device 400 according to a fourth embodiment of the present invention.

FIG. 14 is a schematic view for explaining the configuration of the electronic cigarette device 400.

FIG. 15 is a perspective view for explaining the configuration of the cigarette cartridge 420.

FIG. 16 is a diagram for explaining a state in which the cigarette cartridge 420 is attached to the electronic cigarette device body 410.

FIG. 17 is a partially cut view of the cigarette cartridge 420 according to a first modification.

FIG. 18 is a partially cut view of the cigarette cartridge 420 according to a second modification.

FIGS. 19A and 19B are schematic views for explaining the configuration of an electronic cigarette device 500 according to a fifth embodiment of the present invention, where FIG. 19A illustrates a separated state, and FIG. 19B illustrates an attached state.

FIGS. 20A and 20B are schematic views for explaining the configuration of an electronic cigarette device 600 according to a sixth embodiment of the present invention, where FIG. 20A illustrates a separated state, and FIG. 20B illustrates an attached state.

FIGS. 21A and 21B are schematic views for explaining the configuration of an electronic cigarette device 700 according to a seventh embodiment of the present invention, where FIG. 21A illustrates a separated state, and FIG. 21B illustrates an attached state.

### MODE FOR CARRYING OUT THE INVENTION

Hereinafter, preferred embodiments of the present invention will be described with reference to the accompanying drawings.

### First Embodiment

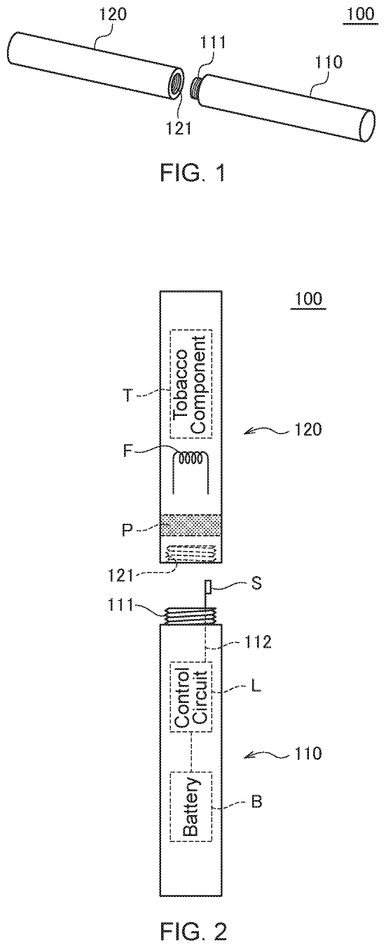

FIG. 1 is a schematic perspective view illustrating the outer appearance of an electronic cigarette device 100 according to the first embodiment of the present invention. FIG. 2 is a schematic view for explaining the configuration of the electronic cigarette device 100.

As illustrated in FIG. 1, the electronic cigarette device 100 according to the present embodiment includes an electronic cigarette device body 110 and a cigarette cartridge 120 allowing a user to smoke when being attached to the electronic cigarette device body 110. Although not particularly limited, the electronic cigarette device body 110 and cigarette cartridge 120 each have a columnar outer shape, and the cigarette cartridge 120 can be attached to the electronic cigarette device body 110 by engaging a male screw 111 formed at one axial end portion of the electronic cigarette device body 110 and a female screw 121 formed at one axial end portion of the cigarette cartridge 120.

The cigarette cartridge 120 has a cylindrical metal case and, as illustrated in FIG. 2, a tobacco component T is accommodated inside the metal case. The tobacco component T may be dried tobacco leaves or an extract obtained through extraction of a predetermined component contained in the tobacco leaves. Further, the tobacco component T may be integral with the cigarette cartridge 120 or may be detachable with respect to the cigarette cartridge 120. In the former case, the cigarette cartridge 120 is, for example, disposable, and after consumption of the tobacco component T by smoking, a new cigarette cartridge 120 is attached to the electronic cigarette device body 110 to allow smoking again. In the latter case, the cigarette cartridge 120 may be disposable, or may be configured to be used plurality of times by attaching a capsule, etc. accommodating the tobacco component T every time the tobacco component T is consumed.

The cigarette cartridge 120 includes a filament F for heating the tobacco component T. When the cigarette cartridge 120 is attached to the electronic cigarette device body 110, current flows from a battery B included in the electronic cigarette device body 110 to the filament F to heat the tobacco component T. When the tobacco component T is heated, it is vaporized to become vapor to be breathed by a user. Power supply to the filament F may be started in response to an operation of a user, such as pressing of a not-shown switch provided on the electronic cigarette device body 110.

As illustrated in FIG. 2, the electronic cigarette device body 110 has a control circuit L and a magnetic sensor S. The magnetic sensor S is provided so as to axially protrude from the electronic cigarette device body 110 and is connected to the control circuit L through a wire 112. Thus, when the magnetic sensor S detects a magnetic field, an output signal based on the detection is supplied to the control circuit L through the wire 112. The control circuit L has a function of analyzing the output signal from the magnetic sensor S.

On the other hand, the cigarette cartridge 120 has a magnetic pattern P serving as a magnetism generation part. The magnetic pattern P only needs to be a member that can generate a magnetic field, but is preferably a pattern printed using magnetic ink, considering cost of adding the magnetic pattern P to the cigarette cartridge 120 and the amount of information embedded in the magnetic pattern P.

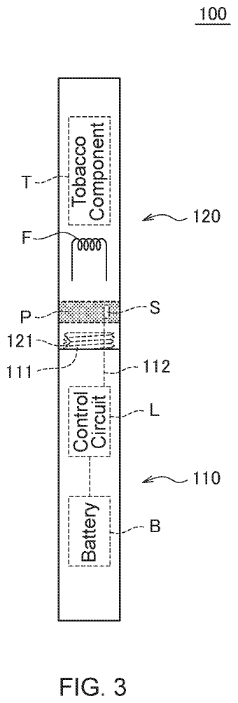

FIG. 3 is a view illustrating a state where the cigarette cartridge 120 is attached to the electronic cigarette device body 110. As illustrated in FIG. 3, when the cigarette cartridge 120 is attached to the electronic cigarette device body 110, the magnetic sensor S faces the magnetic pattern P, allowing the information embedded in the magnetic pattern P to be read by the magnetic sensor S. This allows the information embedded in the magnetic pattern P to be analyzed by the control circuit L.

The information to be embedded in the magnetic pattern P can be the type of the cigarette cartridge 120, the serial number thereof, the manufacturing date thereof, the manufacturing location thereof, the password, and other various items of information concerning the cigarette cartridge 120. Analyzing the information embedded in the magnetic pattern P using the control circuit L allows the electronic cigarette device body 110 to perform a predetermined operation according to a result of the analysis. For example, when the attached cigarette cartridge 120 is determined not to be a genuine product, power supply to the filament F is prohibited, thereby preventing unexpected accident or failure. Further, it is possible to change the heating pattern of the filament F according to the type of the cigarette cartridge 120 and to record a smoking history in a not-shown memory.

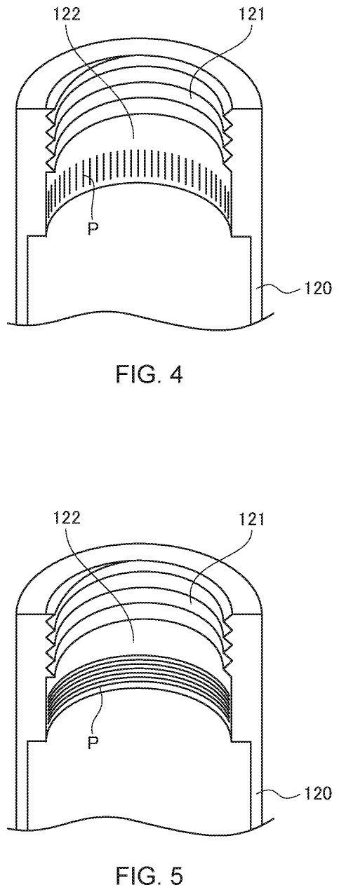

FIG. 4 is a partially cut view of the cigarette cartridge 120.

In the example of FIG. 4, the thickness of the case of the cigarette cartridge 120 is large at one axial end portion thereof, and the female screw 121 and a plurality of the magnetic patterns P are formed in an inner wall 122 of the case. The magnetic patterns P are each an axially extending stripe-like pattern and are peripherally arranged along the inner wall 122 of the case. Thus, when the cigarette cartridge 120 is attached to the electronic cigarette device body 110 by relatively rotating the cigarette cartridge 120 and electronic cigarette device body 110 while engaging the male screw 111 and female screw 121, the plurality of magnetic patterns P can be peripherally scanned by the magnetic sensor S in conjunction with the attachment operation (i.e., rotation operation). The axial positions of the magnetic patterns P and magnetic sensor S are gradually changed with the rotation operation; however, the individual magnetic patterns P have the axially extending stripe shape, so that even when the axial positions thereof are changed, the scanning can be performed properly.

As described above, the plurality of magnetic patterns P are peripherally arranged in the inner wall 122 of the cigarette cartridge 120, so that it is possible to read the information embedded in the magnetic patterns P without a special operation by a user in conjunction with the attachment operation of the cigarette cartridge 120 to the electronic cigarette device body 110. In addition, the configuration in which the magnetic patterns P are peripherally scanned with the rotation operation allows more information to be embedded in the magnetic patterns P. The magnetic patterns P may be formed over the entire periphery of the inner wall 122 of the cigarette cartridge 120, or may be formed only in a predetermined angle range.

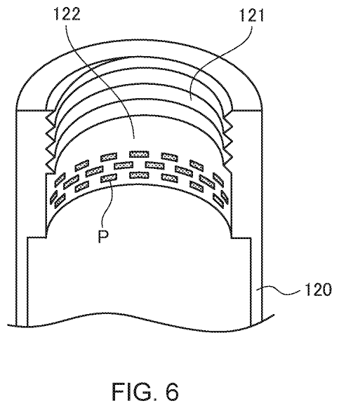

FIGS. 5 and 6 are partially cut views of the cigarette cartridge 120 according to modifications, respectively.

In the example of FIG. 5, the magnetic patterns P are each a peripherally extending ring-like pattern and are axially arranged along the inner wall 122. Thus, when the cigarette cartridge 120 is attached to the electronic cigarette device body 110 by relatively rotating the cigarette cartridge 120 and electronic cigarette device body 110 while engaging the male screw 111 and female screw 121, the plurality of magnetic patterns P can be axially scanned by a change in the axial positions of the magnetic patterns P and magnetic sensor S associated with the rotation operation. With this method, the scan speed of the magnetic sensor S with respect to the magnetic patterns P is reduced, thereby making reading errors or the like less likely to occur.

In the example of FIG. 6, the magnetic patterns P are each a dot-like pattern and are peripherally and axially arranged. Thus, when the cigarette cartridge 120 is attached to the electronic cigarette device body 110 by relatively rotating the cigarette cartridge 120 and electronic cigarette device body 110 while engaging the male screw 111 and female screw 121, the plurality of magnetic patterns P can be peripherally scanned in conjunction with the rotation operation and, at the same time, can also be axially scanned by a change in the axial positions of the magnetic patterns P and magnetic sensor S associated with the rotation operation. This method allows still more information to be embedded in the magnetic patterns P. The same information may be embedded in the dot-like magnetic patterns P. In this case, although the amount of information to be embedded is reduced, it is possible to read the information more reliably since the same information is read plurality of times with the attachment operation.

As described above, in the electronic cigarette device 100 according to the present embodiment, the magnetic patterns P are formed in the cigarette cartridge 120, so that when the cigarette cartridge 120 is attached to the electronic cigarette device body 110, information concerning the cigarette cartridge 120 can be read. In addition, using the magnetic patterns P not only allows sufficient information amount (the number of bits) to be embedded, but also makes reading errors due to positional displacement less likely to occur, thus making it possible to assure accurate reading of the patterns P. Further, when magnetic ink is used to form the magnetic pattern P, cost increase of the cigarette cartridge 120 can be minimized.

### Second Embodiment

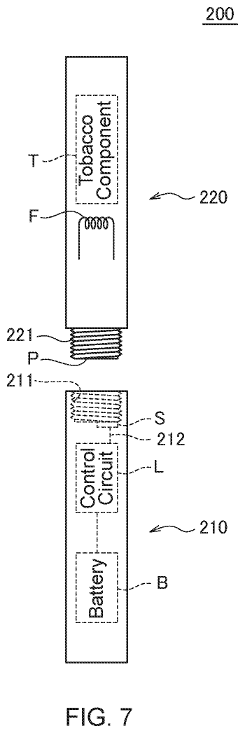

FIG. 7 is a schematic view for explaining the configuration of an electronic cigarette device 200 according to the second embodiment.

As illustrated in FIG. 7, the electronic cigarette device 200 according to the present embodiment includes an electronic cigarette device body 210 and a cigarette cartridge 220 allowing a user to smoke when being attached to the electronic cigarette device body 210. In the present embodiment as well, the electronic cigarette device body 210 and cigarette cartridge 220 each have a columnar outer shape, and the cigarette cartridge 220 can be attached to the electronic cigarette device body 210 by engaging a female screw 211 formed at one axial end portion of the electronic cigarette device body 210 and a male screw 221 formed at one axial end portion of the cigarette cartridge 220.

As in the first embodiment, the electronic cigarette device body 210 has the battery B, control circuit L and magnetic sensor S. The control circuit L and magnetic sensor S are connected to each other through a wire 212. Further, as in the first embodiment, the cigarette cartridge 220 has the tobacco component T, filament F and magnetic pattern P. In the present embodiment, the magnetic pattern P is formed in an axial end surface of the cigarette cartridge 220. The magnetic sensor S is provided at a portion that faces the magnetic pattern P once the cigarette cartridge 220 is attached to the electronic cigarette device body 210.

FIG. 8 is a partially enlarged perspective view of the cigarette cartridge 220.

In the example of FIG. 8, one axial end portion of the cigarette cartridge 220 protrudes in a columnar shape. The male screw 221 is formed in the outer peripheral surface of the columnar protrusion, and a plurality of magnetic patterns Pare formed in the bottom surface thereof. The magnetic patterns P are each a radially extending stripe-like pattern and are radially arranged on the bottom surface of the columnar protrusion. Thus, when the cigarette cartridge 220 is attached to the electronic cigarette device body 210 by relatively rotating the cigarette cartridge 220 and electronic cigarette device body 210 while engaging the male screw 221 and female screw 211, the plurality of magnetic patterns P can be peripherally scanned in conjunction with the attachment operation (i.e., rotation operation). The magnetic sensor S may be disposed at a position corresponding to the radius of the bottom surface of the columnar protrusion as illustrated in FIG. 7 so as to be able to sequentially scan the plurality of magnetic patterns P with the rotation operation.

As described above, the plurality of magnetic patterns P are radially arranged, so that it is possible to read the information embedded in the magnetic patterns P without a special operation by a user in conjunction with the attachment operation of the cigarette cartridge 220 to the electronic cigarette device body 210. The magnetic patterns P may be formed over the entire periphery of the bottom surface of the protrusion of the cigarette cartridge 220 or may be formed only in a predetermined angle range.

In addition to the effects of the first embodiment, the electronic cigarette device 200 according to the present embodiment has an advantage in that the magnetic sensor S is hardly broken since it does not protrude from the electronic cigarette device body 210.

### Third Embodiment

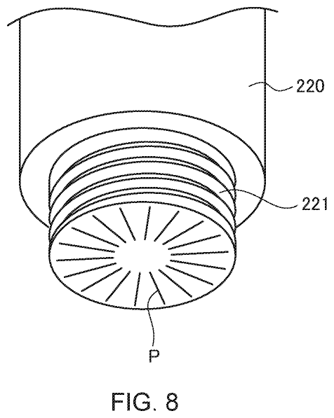

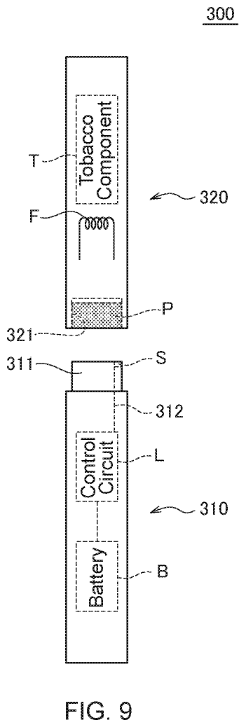

FIG. 9 is a schematic view for explaining the configuration of an electronic cigarette device 300 according to the third embodiment of the present invention.

As illustrated in FIG. 9, the electronic cigarette device 300 according to the present embodiment includes an electronic cigarette device body 310 and a cigarette cartridge 320 allowing a user to smoke when being attached to the electronic cigarette device body 310. In the present embodiment as well, the electronic cigarette device body 310 and cigarette cartridge 320 each have a columnar outer shape, and the cigarette cartridge 320 can be attached to the electronic cigarette device body 310 by inserting a columnar protrusion 311 provided at one axial end portion of the electronic cigarette device body 310 into a cylindrical space provided at one axial end portion of the cigarette cartridge 320. Thus, in the present embodiment, the electronic cigarette device body 310 and cigarette cartridge 320 are attached not by screwing but by axially inserting the cigarette cartridge 320 into the electronic cigarette device body 310.

As in the first embodiment, the electronic cigarette device body 310 has the battery B, control circuit L and magnetic sensor S. The control circuit L and magnetic sensor S are connected to each other through a wire 312. Further, as in the first embodiment, the cigarette cartridge 320 has the tobacco component T, filament F and magnetic pattern P. In the present embodiment, the magnetic pattern P is formed on an inner wall 321 of the cylindrical case. The magnetic sensor S is provided at a portion that faces the magnetic pattern P once the cigarette cartridge 320 is attached to the electronic cigarette device body 310.

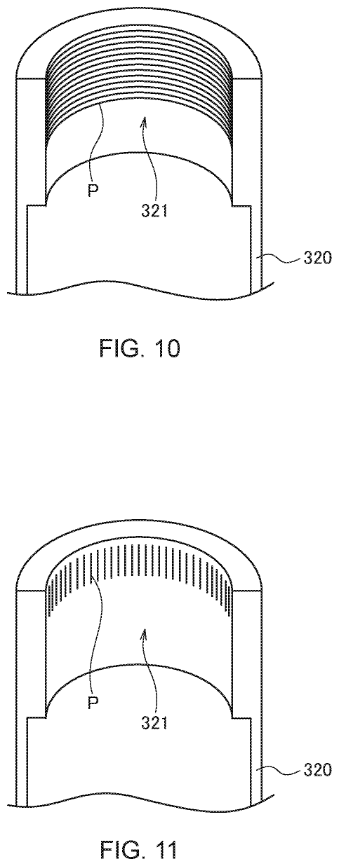

FIG. 10 is a partially cut view of the cigarette cartridge 320.

In the example of FIG. 10, the thickness of the case of the cigarette cartridge 320 is large at one axial end portion thereof, and a plurality of the magnetic patterns P are formed on the inner wall 321 of the thick part of the cylindrical case. The magnetic patterns P are each a peripherally extending ring-like pattern and are axially arranged along the inner wall 321. Thus, when the cigarette cartridge 320 is axially inserted into the electronic cigarette device body 310, the plurality of magnetic patterns P can be axially scanned in conjunction with the attachment operation (i.e., insertion operation). When the cigarette cartridge 320 and electronic cigarette device body 310 are relatively rotated during the insertion operation, a displacement occurs between the peripheral positions of the magnetic patterns P and magnetic sensor S; however, in the present embodiment, the individual magnetic patterns P have a peripherally extending shape, so that even when the peripheral positions thereof are changed, the scanning can be performed properly.

As described above, the plurality of ring-like magnetic patterns P are axially arranged, so that it is possible to read the information embedded in the magnetic patterns P without a special operation by a user in conjunction with the attachment operation of the cigarette cartridge 320 to the electronic cigarette device body 310. In addition, the configuration in which the magnetic patterns P are axially scanned with the insertion operation allows more information to be embedded in the magnetic patterns P. The magnetic patterns P may be formed over the entire periphery of the inner wall 321 of the cigarette cartridge 320, or may be formed only in a predetermined angle range.

In addition to the above-cited effects of the first embodiment, the electronic cigarette device 300 according to the present embodiment has an advantage in that the cigarette cartridge 320 can be attached to the electronic cigarette device body 310 more easily since there is no need to perform the rotation operation at the time of attachment.

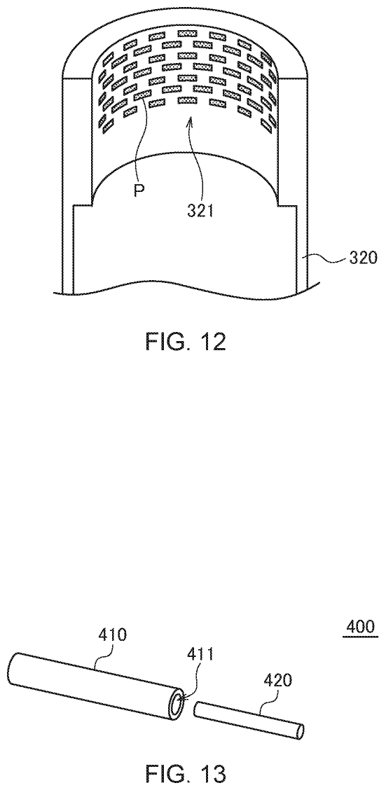

FIGS. 11 and 12 are partially cut views of the cigarette cartridge 320 according to modifications, respectively.

In the example of FIG. 11, the magnetic patterns P are each an axially extending stripe-like pattern and are peripherally arranged along the inner wall 321. Thus, by relatively rotating the cigarette cartridge 320 and electronic cigarette device body 310 when the cigarette cartridge 320 is inserted into the electronic cigarette device body 310, the plurality of magnetic patterns P can be peripherally scanned.

In the example of FIG. 12, the magnetic patterns P are each a dot-like pattern and are peripherally and axially arranged. Thus, by relatively rotating the cigarette cartridge 320 and electronic cigarette device body 310 when the cigarette cartridge 320 is inserted into the electronic cigarette device body 310, the plurality of magnetic patterns P can be peripherally and axially scanned. The same information may be embedded in the dot-like magnetic patterns P.

### Fourth Embodiment

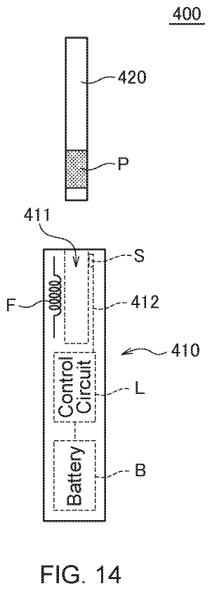

FIG. 13 is a schematic view for explaining the configuration of an electronic cigarette device 400 according to the fourth embodiment of the present invention. FIG. 14 is a schematic view for explaining the configuration of the electronic cigarette device 400.

As illustrated in FIG. 13, the electronic cigarette device 400 according to the present embodiment includes an electronic cigarette device body 410 and a cigarette cartridge 420 allowing a user to smoke when being attached to the electronic cigarette device body 410. In the present embodiment as well, the electronic cigarette device body 410 and cigarette cartridge 420 each have a columnar outer shape, and the cigarette cartridge 420 can be attached to the electronic cigarette device body 410 by axially inserting the cigarette cartridge 420 into a cylindrical space 411 provided at one axial end portion of the electronic cigarette device body 410.

As illustrated in FIG. 14, in the present embodiment, the filament F is provided on the electronic cigarette device body 410 side. Thus, when the cigarette cartridge 420 is attached to the electronic cigarette device body 410, the cigarette cartridge 420 is heated by the filament F provided in the electronic cigarette device body 410, whereby vapor generated by the heating can be breathed by a user. The magnetic sensor S is provided on the inner wall part constituting the space 411 of the electronic cigarette device body 410 and connected to the control circuit L through a wire 412.

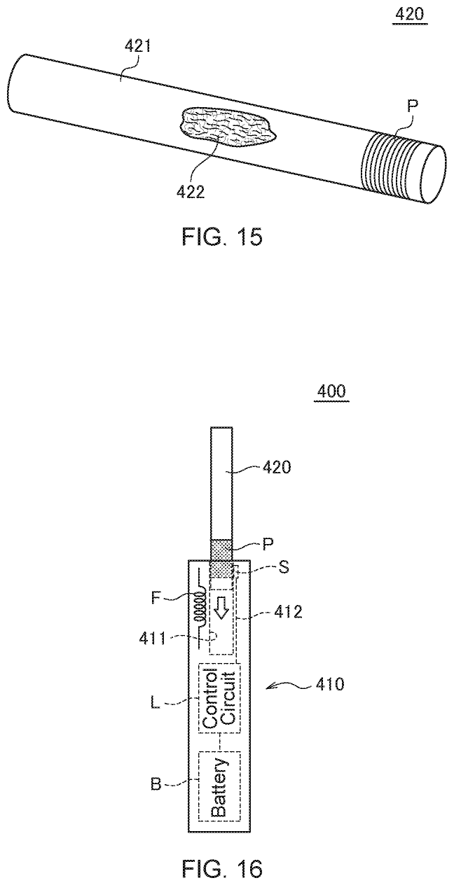

FIG. 15 is a perspective view for explaining the configuration of the cigarette cartridge 420.

As illustrated in FIG. 15, the cigarette cartridge 420 used in the present embodiment includes a wrapping paper 421 wound into a cylindrical shape and tobacco leaves 422 wrapped in the wrapping paper 421. A plurality of peripherally extending ring-shaped magnetic patterns P are axially arranged near the leading end of the wrapping paper 421. The magnetic patterns P are formed by, e.g., magnetic ink printed on the wrapping paper 421. The magnetic patterns P may be printed on the outer or inner surface of the wrapping paper 421.

Alternatively, a configuration may be possible, in which the magnetic patterns P are printed on a backing sheet different from the wrapping paper 421, and the backing sheet is attached to the outer or inner surface of the wrapping paper 421.

When the thus configured cigarette cartridge 420 is inserted into the cylindrical space 411 provided in the electronic cigarette device body 410, the plurality of magnetic patterns P can be axially scanned by the magnetic sensor S in conjunction with the attachment operation (i.e., insertion operation), as illustrated in FIG. 16. When the cigarette cartridge 420 and electronic cigarette device body 410 are relatively rotated during the insertion operation, a displacement occurs between the peripheral positions of the magnetic patterns P and magnetic sensor S; however, in the present embodiment, the individual magnetic patterns P have the peripherally extending ring shape, so that even when the peripheral positions thereof are changed, the scanning can be performed properly.

As exemplified in the present embodiment, a heating means such as the filament F may not necessarily be provided in the cigarette cartridge 420 itself, but it may be provided on the electronic cigarette device body 410 side in the present invention. In this configuration, the cigarette cartridge 420 is inevitably configured to be disposable and can therefore be used only once, so that there occurs a necessity of suppressing cost increase of the cigarette cartridge 420. In this regard, in the present embodiment, the cigarette cartridge 420 can be realized by simply printing the magnetic patterns P using, e.g., magnetic ink on the wrapping paper 421 constituting the cigarette cartridge 420, thus making it possible to minimize cost increase of the cigarette cartridge 420.

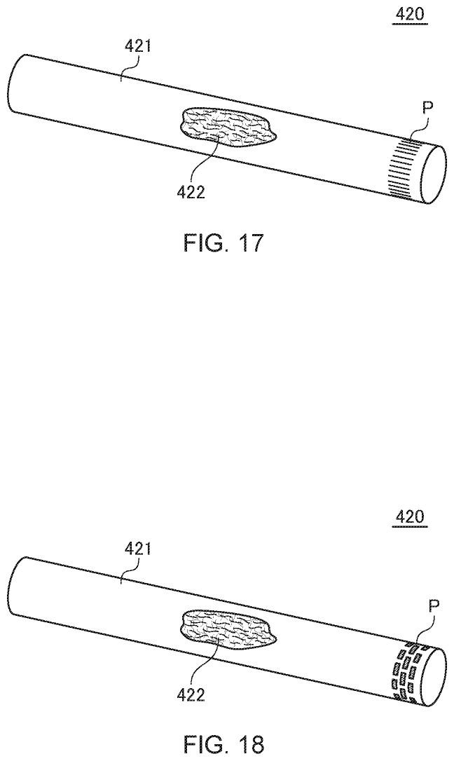

FIGS. 17 and 18 are partially cut views of the cigarette cartridge 420 according to modifications, respectively.

In the example of FIG. 17, the magnetic patterns P are each an axially extending stripe-like pattern and are peripherally arranged near the leading end of the wrapping paper 421. Thus, by relatively rotating the cigarette cartridge 420 and electronic cigarette device body 410 when the cigarette cartridge 420 is inserted into the electronic cigarette device body 410, the plurality of magnetic patterns P can be peripherally scanned.

In the example of FIG. 18, the magnetic patterns P are each a dot-like pattern and are peripherally and axially arranged. Thus, by relatively rotating the cigarette cartridge 420 and electronic cigarette device body 410 when the cigarette cartridge 420 is inserted into the electronic cigarette device body 410, the plurality of magnetic patterns P can be peripherally and axially scanned. The same information may be embedded in the dot-like magnetic patterns P.

### Fifth Embodiment

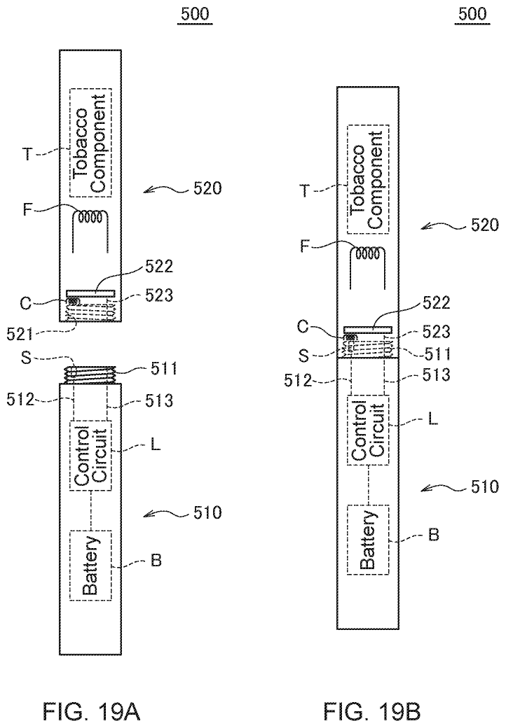

FIGS. 19A and 19B are schematic views for explaining the configuration of an electronic cigarette device 500 according to the fifth embodiment of the present invention, where FIG. 19A illustrates a separated state, and FIG. 19B illustrates an attached state.

As illustrated in FIG. 19A, the electronic cigarette device 500 according to the present embodiment includes an electronic cigarette device body 510 and a cigarette cartridge 520 allowing a user to smoke when being attached to the electronic cigarette device body 510. In the present embodiment as well, the electronic cigarette device body 510 and cigarette cartridge 520 each have a columnar outer shape, and the cigarette cartridge 520 can be attached to the electronic cigarette device body 510 by engaging a male screw 511 formed at one axial end portion of the electronic cigarette device body 510 and a female screw 521 formed at one axial end portion of the cigarette cartridge 520.

As in the first embodiment, the electronic cigarette device body 510 has the battery B, control circuit L and magnetic sensor S. The control circuit L and magnetic sensor S are connected to each other through a wire 512. Further, as in the first embodiment, the cigarette cartridge 520 has the tobacco component T and filament F. In the present embodiment, a substrate 522 is provided in the cigarette cartridge 520, and a coil C serving as a magnetism generation part is mounted on the substrate 522.

As illustrated in FIG. 19B, when the cigarette cartridge 520 is attached to the electronic cigarette device body 510, a wire 513 provided in the electronic cigarette device body 510 and a wire 523 provided in the cigarette cartridge 520 are brought into conduction, whereby current flows in the coil C. The coil C is at a position facing the magnetic sensor S in the attachment state, so that when current is made to flow in the coil C, a generated magnetic field can be detected by the magnetic sensor S.

A current pattern to be made to flow in the coil C is programmed in advance in the control circuit L. Thus, the control circuit L can determine, based on an output signal from the magnetic sensor S, whether or not a magnetic field corresponding to the programmed current pattern is properly generated, and the electronic cigarette device body 510 can perform a predetermined operation according to a determination result output from the control circuit L. For example, when it is determined that a magnetic field corresponding to the programmed current pattern is not generated, it is conceivable that the attached cigarette cartridge 520 is not a genuine product or that the cigarette cartridge 520 (even if it is a genuine one) is not properly attached to the electronic cigarette device body 510. Thus, in this case, it is possible to prevent unexpected accident or failure by prohibiting power supply to the filament F.

As exemplified in the present embodiment, the magnetism generation part added to the cigarette cartridge 520 may not necessarily be the magnetic pattern P formed by magnetic ink but may be the coil C. According to the present embodiment, it is more difficult to imitate the cigarette cartridge 520 than when the magnetic pattern P is used, so that it can be expected that imitations can be eliminated more reliably.

### Sixth Embodiment

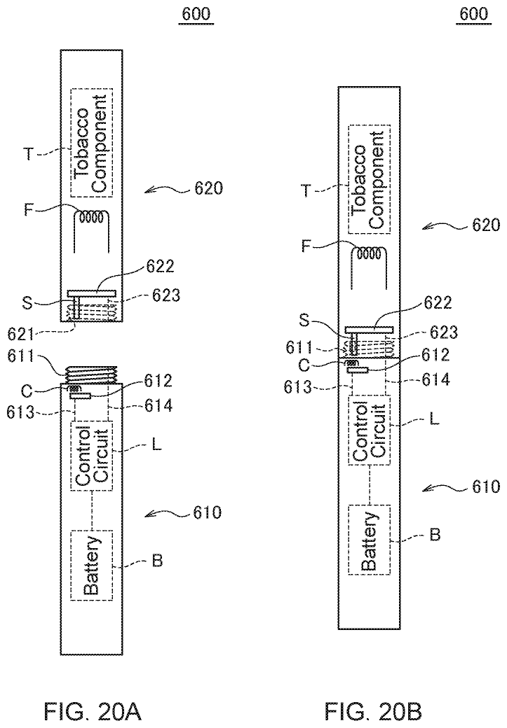

FIGS. 20A and 20B are schematic views for explaining the configuration of an electronic cigarette device 600 according to the sixth embodiment of the present invention, where FIG. 20A illustrates a separated state, and FIG. 20B illustrates an attached state.

As illustrated in FIG. 20A, the electronic cigarette device 600 according to the present embodiment includes an electronic cigarette device body 610 and a cigarette cartridge 620 allowing a user to smoke when being attached to the electronic cigarette device body 610. In the present embodiment as well, the electronic cigarette device body 610 and cigarette cartridge 620 each have a columnar outer shape, and the cigarette cartridge 620 can be attached to the electronic cigarette device body 610 by engaging a male screw 611 formed at one axial end portion of the electronic cigarette device body 610 and a female screw 621 formed at one axial end portion of the cigarette cartridge 620.

The electronic cigarette device body 610 has the battery B, control circuit L and a substrate 612, and the coil C is mounted on the substrate 612. The coil C is supplied with current through a wire 613. Further, as in the first embodiment, the cigarette cartridge 620 has the tobacco component T and filament F. In the present embodiment, a substrate 622 is provided in the cigarette cartridge 620, and the magnetic sensor S is mounted on the substrate 622.

As illustrated in FIG. 20B, when the cigarette cartridge 620 is attached to the electronic cigarette device body 610, a wire 614 provided in the electronic cigarette device body 610 and a wire 623 provided in the cigarette cartridge 620 are brought into conduction, whereby the magnetic sensor S is connected to the control circuit L. The magnetic sensor S is at a position facing the coil C in the attachment state, so that when current is made to flow in the coil C, a generated magnetic field can be detected by the magnetic sensor S.

A current pattern to be made to flow in the coil C is programmed in advance in the control circuit L. Thus, as in the fifth embodiment, the control circuit L can determine, based on an output signal from the magnetic sensor S, whether or not a magnetic field corresponding to the programmed current pattern is properly generated, whereby the same effect as that in the fifth embodiment can be obtained.

As exemplified in the present embodiment, in the present invention, the magnetism generation part such as the coil C may not necessarily be provided in the cigarette cartridge 620, but the magnetic sensor S may be provided therein in place of the coil C.

### Seventh Embodiment

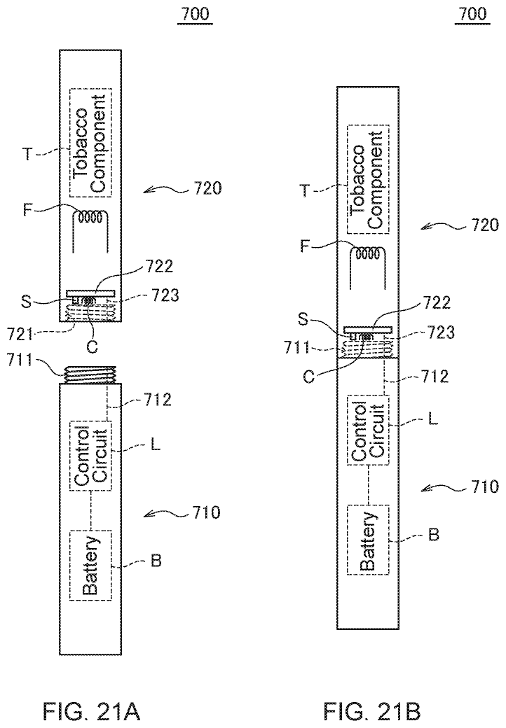

FIGS. 21A and 21B are schematic views for explaining the configuration of an electronic cigarette device 700 according to the seventh embodiment of the present invention, where FIG. 21A illustrates a separated state, and FIG. 21B illustrates an attached state.

As illustrated in FIG. 21A, the electronic cigarette device 700 according to the present embodiment includes an electronic cigarette device body 710 and a cigarette cartridge 720 allowing a user to smoke when being attached to the electronic cigarette device body 710. In the present embodiment as well, the electronic cigarette device body 710 and cigarette cartridge 720 each have a columnar outer shape, and the cigarette cartridge 720 can be attached to the electronic cigarette device body 710 by engaging a male screw 711 formed at one axial end portion of the electronic cigarette device body 710 and a female screw 721 formed at one axial end portion of the cigarette cartridge 720.

The electronic cigarette device body 710 has the battery B and control circuit L. Further, as in the first embodiment, the cigarette cartridge 720 has the tobacco component T and filament F. In the present embodiment, a substrate 722 is provided in the cigarette cartridge 720, and the coil C and magnetic sensor S are mounted on the substrate 722.

As illustrated in FIG. 21B, when the cigarette cartridge 720 is attached to the electronic cigarette device body 710, a wire 712 provided in the electronic cigarette device body 710 and a wire 723 provided in the cigarette cartridge 720 are brought into conduction, whereby the coil C and magnetic sensor S are connected to the control circuit L. The magnetic sensor S is disposed near the coil C, so that when current is made to flow in the coil C, a generated magnetic field can be detected by the magnetic sensor S.

A current pattern to be made to flow in the coil C is programmed in advance in the control circuit L. Thus, as in the fifth embodiment, the control circuit L can determine, based on an output signal from the magnetic sensor S, whether or not a magnetic field corresponding to the programmed current pattern is properly generated, whereby the same effect as that in the fifth embodiment can be obtained.

As exemplified in the present embodiment, in the present invention, both the magnetism generation part such as the coil C and magnetic sensor S may be provided in the cigarette cartridge 720.

While the preferred embodiments of the present invention have been described, the present invention is not limited to the above embodiments, and various modifications may be made without departing from the gist of the present invention, and all such modifications are included in the present invention.

For example, although both the electronic cigarette device body and cigarette cartridge have the columnar outer shape in the above embodiments, the outer shapes thereof are not limited to this.

### REFERENCE SIGNS LIST

100, 200, 300, 400, 500, 600, 700 electronic cigarette device
110, 210, 310, 410, 510, 610, 710 electronic cigarette device body
120, 220, 320, 420, 520, 620, 720 cigarette cartridge
111, 221, 511, 611, 711 male screw
121, 211, 521, 621, 721 female screw
112, 212, 312, 412, 512, 513, 523, 613, 614, 623, 712, 723 wire
311 protrusion
112, 321 inner wall
411 space
421 wrapping paper
422 tobacco leaves
522, 612, 622, 722 substrate
B battery
C coil
F filament
L control circuit
P magnetic pattern
S magnetic sensor
T tobacco component

1. A cigarette cartridge allowing a user to smoke when being attached to an electronic cigarette device body, the cigarette cartridge comprising at least one of a magnetism generation part that generates a magnetic field indicating predetermined information and a magnetic sensor that detects the magnetic field.

2. The cigarette cartridge as claimed in claim 1, wherein the cigarette cartridge comprises the magnetism generation part including a plurality of magnetic patterns.

3. The cigarette cartridge as claimed in claim 2, wherein the plurality of magnetic patterns extending in a axial direction are arranged in a circumferential direction when an attachment direction of the cigarette cartridge to the electronic cigarette device body is the axial direction.

4. The cigarette cartridge as claimed in claim 2, wherein the plurality of magnetic patterns extending in a radial direction are radially arranged when an attachment direction of the cigarette cartridge to the electronic cigarette device body is an axial direction.

5. The cigarette cartridge as claimed in claim 2, wherein the plurality of magnetic patterns extending in a circumferential direction are arranged in an axial direction when an attachment direction of the cigarette cartridge to the electronic cigarette device body is the axial direction.

6. The cigarette cartridge as claimed in claim 2, wherein the plurality of dot-like magnetic patterns are arranged in a circumferential direction and an axial direction when an attachment direction of the cigarette cartridge to the electronic cigarette device body is the axial direction.

7. The cigarette cartridge as claimed in claim 3, wherein the cigarette cartridge can be threadably engaged to the electronic cigarette device body having the magnetic sensor by peripherally rotating the cigarette cartridge.

8. The cigarette cartridge as claimed in claim 3, wherein the cigarette cartridge can be attached to the electronic cigarette device body having the magnetic sensor by axially inserting the cigarette cartridge.

9. The cigarette cartridge as claimed in claim 1, wherein the cigarette cartridge comprises the magnetism generation part including a coil.

10. An electronic cigarette device having an electronic cigarette device body and a cigarette cartridge allowing a user to smoke when being attached to the electronic cigarette device body, the electronic cigarette device comprising:
a magnetism generation part that generates a magnetic field indicating predetermined information;
a magnetic sensor that detects the magnetic field; and
a control circuit that analyzes an output signal from the magnetic sensor,
wherein the control circuit is provided in the electronic cigarette device body,
wherein at least one of the magnetism generation part and magnetic sensor is provided in the cigarette cartridge, and
wherein the magnetic field generated by the magnetism generation part can be detected by the magnetic sensor when the cigarette cartridge is attached to the electronic cigarette device body.

11. The electronic cigarette device as claimed in claim 10,
wherein the magnetism generation part includes a plurality of magnetic patterns formed in the cigarette cartridge, and
wherein the magnetic sensor is provided in the electronic cigarette device body.

12. The electronic cigarette device as claimed in claim 11, wherein the plurality of magnetic patterns extending in an axial direction are arranged in a circumferential direction in the cigarette cartridge when an attachment direction of the cigarette cartridge to the electronic cigarette device body is the axial direction.

13. The electronic cigarette device as claimed in claim 11, wherein the plurality of magnetic patterns extending in a radial direction are radially arranged in the cigarette cartridge when an attachment direction of the cigarette cartridge to the electronic cigarette device body is an axial direction.

14. The electronic cigarette device as claimed in claim 11, wherein the plurality of magnetic patterns extending in a circumferential direction are arranged in an axial direction in the cigarette cartridge when an attachment direction of the cigarette cartridge to the electronic cigarette device body is the axial direction.

15. The electronic cigarette device as claimed in claim 11, wherein the plurality of dot-like magnetic patterns are arranged in a circumferential direction and an axial direction in the cigarette cartridge when an attachment direction of the cigarette cartridge to the electronic cigarette device body is the axial direction.

16. The electronic cigarette device as claimed in claim 11, wherein the magnetic sensor detects the magnetic field in conjunction with an attachment operation of attaching the cigarette cartridge to the electronic cigarette device body.

17. The electronic cigarette device as claimed in claim 16, wherein the attachment operation includes a rotation operation with an axial direction set as a rotating axis or an axial insertion operation when an attachment direction of the cigarette cartridge to the electronic cigarette device body is the axial direction.

18. The electronic cigarette device as claimed in claim 10,
wherein the magnetism generation part includes a coil, and
wherein the control circuit makes current flow in the coil in a state where the cigarette cartridge is attached to the electronic cigarette device body.
